(19) United States
(12) Patent Application Publication
(10) Pub. No.: US 2007/0169164 A1
(43) Pub. Date: Jul. 19, 2007

(54) System and method for broadcasting personalizes and where applicable interactive contents to terminals attached to a communication network

(75) Inventors: Emmanuel Marilly, Saint-Michel-sur-Orge (FR); Gerard Delegue, Cachan (FR); Olivier Martinot, Draveil (FR); Stephane Betge-Brezetz, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/516,777

(22) Filed: Sep. 7, 2006

(30) Foreign Application Priority Data
Sep. 8, 2005 (FR) 0552710

(51) Int. Cl. H04N 7/16

(52) U.S. Cl. 725/135; 725/138; 725/62

(57) ABSTRACT

A system (MD, SC, MT) is dedicated to broadcasting content data streams to communication terminals (T1-T3) attached at least to a first broadcast network (R1). The system comprises at least i) data content definition means (MD) adapted to insert at least interactivity points at selected places in contents to be broadcast in the form of streams, each corresponding to the triggering at a selected time of a service application belonging to a group of at least two selected applications, ii) a content server (SC) adapted to broadcast content data streams supplied by said definition means (MD) to terminals (T1-T3) via said first network (R1), and iii) processing means (MT) installed in terminals (T1-T3), further including display means (MA) adapted to display data contained in streams received from said content server (SC) and adapted to analyze the data of said streams in order, in the event of detection of an interactivity point, to determine the corresponding service application as a function of at least one selected criterion relating at least to the user of their terminal and/or to said terminal and to command the display means (MA) of their terminal (T1-T3) to execute that service application.

The invention relates to fixed or mobile communication networks, more precisely to broadcasting contents via such networks to communication terminals that are adapted to receive broadcast contents and incorporate a communication function (for example of the GSM, GPRS, UMTS or WiFi type).

In the present context the term “content” refers to voluminous sets of data defining a television or video or audio (radiophonic or musical) or multimedia program or games or a computer (or data) file.

In order to satisfy as many customers as possible, content broadcasters must make available to them personalized services or groups of services from which they may choose interactively. At present no solution has been proposed for achieving this objective. A content broadcaster can offer its customers only a single interactive service that is deemed to correspond to the greatest subset of them, as defined by an average profile. For example, a television program broadcaster can only send all terminals able to receive its programs the same question relating to a broadcast. This does not constitute a personalized service.

An object of the invention is therefore to improve upon the situation and in particular to enable personalization and adaptation of interactive content transmitted to user terminals, for example as a function of their user profiles.

To this end it proposes a method of broadcasting content data streams to communication terminals attached to at least one first broadcast network, characterized in that it consists
in inserting at least interactivity points at selected places in contents to be broadcast in the form of streams, each corresponding to the triggering at a selected time of a service application belonging to a group of at least two selected applications, and
in the event of reception in a destination terminal of the streams broadcast via the first network, displaying the data that they contain and, in the event of detecting an interactivity point, determining the corresponding service application as a function of at least one selected criterion relating at least to the user of the terminal and/or to the terminal, so that the service application is executed by the terminal.

The method of the invention may have other features, and in particular, separately or in combination:
each criterion may be selected from a group comprising at least a terminal user profile criterion (for example the user's tastes, age or sex), a terminal type criterion, a terminal location criterion and a return channel (or back channel) type criterion;
some of the service applications may be of the interactive type, for example;
   the interactive service applications may be selected from a group comprising at least a betting application, a voting application, a purchasing application and a personalized data downloading application (for example telephone ringtones, text messages, videos or advertisements), for example;
   in the event of executing an interactive service application in a terminal, messages may be exchanged via a return channel set up between the terminal and a selected address of the first network (if it provides (one-way) broadcasting at the same time as two-way (back channel) communication) or of a two-way second communication network (incorporating back channels) under the control of the user of the terminal;
at least one of the service applications may be dedicated to displaying at least one selected advertisement, for example;
the contents to be broadcast may integrate data representing service applications of each group corresponding to an interactivity point; thus the service application to be executed may be determined in a terminal as a function of each selected criterion (defined by the user of the terminal or by the broadcast operator (in the latter case each criterion definition is sent to the corresponding terminal via a return channel));
in a first embodiment the contents to be broadcast may integrate data representing a first portion of each service application of each group corresponding to an interactivity point; thus, in the event of detection of an interactivity point in a terminal, a request may be sent to a selected network address via a return channel thereof to obtain each second portion that is complementary to a first service application portion that has been received, and then, on receiving each second portion, the service application may be determined in the terminal as a function of each selected criterion (defined by the user of the terminal or by the broadcast operator) in order for it to be possible to execute it;
in a second embodiment, in the event of detection of an interactivity point in a terminal, a service application request may be sent to a selected network address via a return channel; in this case, on reception of that request, the required service application may be determined as a function of each selected criterion corresponding to the requesting terminal (and defined by the broadcast operator) and the service application may be sent to the requesting terminal in order for it to be able to execute it.

The invention also proposes a system for broadcasting content data streams to communication terminals attached at least to a first broadcast network, characterized in that it comprises at least:
data content definition means adapted to insert at least interactivity points at selected places in contents to be broadcast in the form of streams, each corresponding to the triggering at a selected time of a service application belonging to a group of at least two selected applications,
a content server adapted to broadcast content data streams supplied by the definition means to terminals via the first network, and
processing means installed in communication terminals (further including display means adapted to display data contained in streams received from the content server) and adapted to analyze the data of the streams in order, in the event of detection of an interactivity point, to determine the corresponding service application as a function of at least one selected criterion relating at least to the user of the terminal and/or to the terminal, and to command the display means of their terminal to execute that service application.

The system of the invention may have other features and in particular, separately or in combination:
each criterion may be selected from a group comprising at least a terminal user profile criterion, a terminal type criterion and a terminal location criterion, and where applicable a return channel type criterion, for example;
it may comprise control equipment that is accessible at a selected address via a return channel of the first network or a bidirectional second communication network and includes service application request management means and the processing means of a terminal are adapted, in the event of execution of an interactive type service application by the associated display means, to exchange messages with the service application request management means via a return channel set up between its control equipment and the terminal and under the control of the user of the terminal;
the definition means may be adapted to integrate into the contents to be broadcast data representing the service applications of each group corresponding to an interactivity point; in this case, the processing means of each terminal may be adapted to determine the service application to be executed by the associated display means as a function of each selected criterion (for example stored locally and defined by the terminal user or by the broadcast operator and sent to the corresponding terminal via the return channel);
in a first embodiment the definition means may be adapted to integrate into the contents to be broadcast data representing a first portion of each service application of each group corresponding to an interactivity point; in this case, the control equipment may comprise control means adapted to determine on demand data representing second service application portions complementary to the first portions; the processing means of each terminal may then be adapted, in the event of detection of an interactivity point, to send the control equipment via the return channel a request to obtain second portions complementary to first service application portions that have been received and, on reception of each second portion, to determine the service application as a function of each selected criterion (for example stored locally and defined by the terminal user or by the broadcast operator and sent to the corresponding terminal via the return channel) and to command the display means of the terminal to execute that service application;
in a second embodiment the processing means of each terminal may be adapted, in the event of detection of an interactivity point, to send the control equipment a service application request via the return channel; in this case, the control equipment may comprise control means adapted, on receiving a service application request, to determine each criterion definition corresponding to the requesting terminal and data representing service applications and then to determine the required service application as a function of each criterion that has been determined and to generate a message including data representing the service application that has been determined in order for the control equipment to send it to the requesting terminal via the return channel, after which the display means of the terminal execute that service application under the control of its processing means.

The invention is particularly well adapted, although not exclusively so, to a one-way broadcast network, for example a terrestrial (DVB-H or cable) or satellite (Satellite Digital Media Broadcast (SDMB)) broadcast network, coupled to at least one two-way communication network, for example a mobile (or cellular) network, possibly a satellite network.

Other features and advantages of the invention will become apparent on reading the following detailed description and examining the appended drawings, in which:

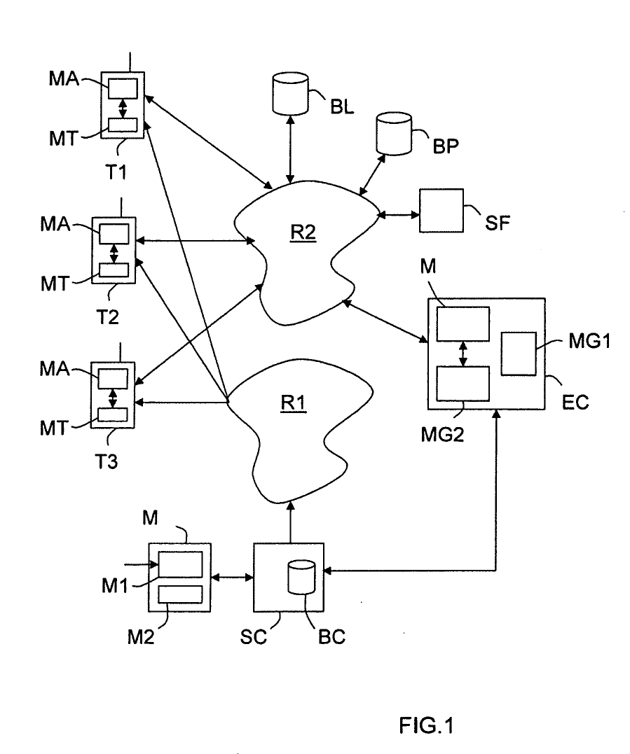

FIG. 1 is a diagram showing a broadcast network coupled to a two-way communication network and one embodiment of a data broadcasting system of the invention, and

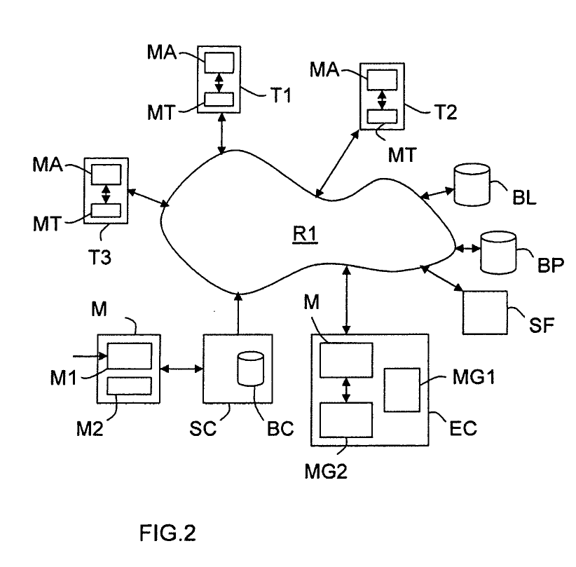

FIG. 2 is a diagram showing part of a two-way communication network and one embodiment of a data broadcasting system of the invention.

The appended drawings constitute part of the description of the invention as well as contributing to the definition of the invention, if necessary.

An object of the invention is for a communication network to broadcast personalized and where applicable interactive contents and services to communication terminals (which in some cases incorporate a receiver using two different technologies, for example DVB-H and UMTS), via one or two networks, one of which is dedicated to broadcasting.

This invention applies to any type of fixed or mobile communication terminal (which in some cases incorporates a receiver using two different technologies, for example DVB-H and UMTS), provided that the terminal can be connected either to a fixed two-way communication network simultaneously providing one-way broadcasting and two-way communication via return channels (for example networks including medium- or high-bit-rate two-way data transmission lines, such as cables (or optical fibers) or xDSL type lines), or to a fixed one-way broadcast network (for example of the DVB-H type) and at the same time to a two-way communication network, for example a mobile or cellular network (preferably of the UMTS type or its variants and equivalents), where applicable via a modem (modulator/demodulator). For example, the terminal could be a mobile (or cellular) telephone, a personal digital assistant (PDA), an encrypted television or video program decoder, a set-top box type television program receiver, a video or music program receiver, a fixed or portable computer, or equipment on-board a vehicle (automobile, truck, bus, train and the like).

A first embodiment of the invention is described with reference to FIG. 1.

In this first embodiment, a first network R1 that is dedicated to one-way broadcasting of contents to multifrequency receiver terminals is coupled to a mobile or cellular second network R2 that is dedicated to two-way communication via return channels.

By way of nonlimiting example, the communication terminals (hereinafter referred to as “terminals”) considered here are mobile telephones incorporating a receiver using two different technologies, one of the UMTS type enabling them to connect to the second network R2 in order to set up two-way calls and the other of the Digital Video Broadcasting-Handheld terminal (DVB-H) type enabling them to connect to the first network R1 to receive, by radio, audio and/or television and/or video and/or multimedia programs and/or games and/or data files, for example.

As shown in FIG. 1, the invention proposes a system dedicated to broadcasting content data streams to terminals Ti. In the present example there are only three mobile terminals T1 to T3 (i=1 to 3). However, the suffix i may take any value greater than zero (0).

This system includes at least a data content definition module MD, a broadcast content server SC and processing modules MT installed in the terminals Ti.

For example, the (data content) definition module MD comprises a first sub-module M1 fed with contents to be broadcast, for example television, video or music (voice) programs or computer files. This first sub-module M1 receives contents at least from interactivity points each of which corresponds to the triggering at a selected time of a service application belonging to a group of at least two selected applications, and inserts those contents at selected locations. In other words, an interactivity point is a kind of time marker that is placed in a content before it is broadcast in the form of a stream and is associated with a group of service applications. Consequently, when an interactivity point is detected in a content data stream, it designates a group of service applications within which an application must be selected in order to be executed locally (see below).

In the present context, the expression “service application” refers to an interactive or non-interactive electronic data processing application which offers a service to the user of a terminal Ti when it is executed by the display module (or viewer) MA of the terminal Ti. An application of this kind takes the form of an executable script or an executable program, for example.

Interactive service applications include applications for betting, voting, purchasing and downloading personalized data (for example telephone ringtones, text messages, videos, advertisements, games, quizzes, security information, general or specialized information (for example stock market, bank, government or road information)).

Non-interactive service applications include applications for displaying advertisement(s) and for the non-interactive supply of security information or general or specialized information.

The definition module MD may be installed in a computer (or a workstation), for example, and use its man/machine interface to control the first sub-module M1.

The locations at which to place the interactivity points are selected by a technician working for the content broadcaster as a function of requirements and/or constraints. The technician may be assisted in this task by a second sub-module M2 of the definition module MD. This second sub-module M2 is adapted to propose groups, where applicable predefined groups, of service applications corresponding to a type of content to be broadcast, for example. When the technician must insert interactivity points into a content, he determines the type of content and looks up the group of service applications that corresponds to that type of content in a list offered by the second sub-module M2, for example. The second sub-module M2 can also supply the interactivity point that corresponds to each group. Of course, the technician can define his own groups and the corresponding interactivity points.

When interactivity points have been inserted into a content (where applicable with the interactive service—see below), the definition module MD communicates them to the content server SC, either directly (as shown in FIG. 1) if the definition module MD is physically connected to the content server SC or indirectly, via a third network, for example of the IP (Internet Protocol) type, to which the definition module MD and the content server SC may be connected.

The content server SC, which here is connected to the first network R1, preferably contains a database BC in which it stores the contents to be broadcast, as communicated by the definition module MD. Its main function is to broadcast at selected times content data streams to terminals Ti that are, like it, attached to the first network R1. These streams are broadcast on one-way transmission channels dedicated to this function by the first network R1.

The content server SC may also send the terminals Ti the electronic program guide (EPG) and/or manage all aspects of encryption or encoding of the streams to be broadcast and digital rights (authors' rights and legal content protection).

Each processing module MT is coupled to a display module (or viewer) MA of the terminal Ti in which it is installed. The display module MA displays on a screen of its terminal Ti the content data streams that it receives (here) from the first network R1. It is also able to execute service applications as defined above, i.e. to activate them and display on the screen the data that they communicate to it.

Each processing module MT analyzes the data contained in the content streams received by the display module MA to which it is coupled in order to detect each inserted interactivity point. Moreover, each time that the processing module MT detects an interactivity point, it determines the service application that corresponds to it as a function of at least one selected criterion relating at least to the user of its terminal Ti and/or the terminal Ti (type and/or location) and/or the return channel used by the terminal Ti in the case of an interactive service.

The criteria that may be used include:
A terminal Ti user profile criterion. A profile may cover a single user or a group of users. For example, it may cover one or more characteristics, for example age, sex, program type preferences, tastes, areas of interest, leisure activities, program viewing time bands, and generally anything that can be used to personalize a user.
A terminal Ti type criterion. Here the terminal Ti type refers to the operating system (OS) and/or performance (or capacities) and/or the codec(s) supported and/or the screen size and/or the functions used and/or the identification of the terminal Ti.
A terminal Ti location criterion. Here the location of a terminal Ti refers to its geographical position (latitude, longitude and where applicable altitude) or a geographical area to which it belongs. It may be obtained by any means, in particular by GPS equipment installed in the mobile terminal Ti or from the known GSM or GPRS cell to which the mobile terminal Ti is attached or the DVB-H transmitter that is broadcasting the contents received by the mobile terminal Ti.
A return channel type criterion (in the case of an interactive service). Here the return channel type refers primarily to its performance, for example in terms of quality of service (QoS), and/or its technical characteristics (for example UMTS or GPRS).

One or more criteria may be used to determine the service applications that a terminal Ti has to execute.

The processing module MT also commands the display module MA of its terminal Ti to execute each service application that it has determined.

When there are interactive type service applications, the broadcasting system of the invention must also include a control equipment EC accessible to the terminals Ti via the second (communication) network R2 at a selected address.

This control equipment EC is coupled to the content server SC, preferably via the management network of the content broadcaster or via a third network, for example of the IP type.

It comprises a service application request management module MG1 for analyzing each message or request sent by a terminal Ti on a return channel (or back channel) when its display module MA executes an interactive service application and for carrying out the operations that follow from the content of the message or the request. For example, if the service application is a mail order application, the service application request management module MG1 provides the interface between the terminal Ti making the purchase and the server SF that sells the article purchased or controls billing and is accessible via the second network R2. If the service application is a voting application, the service application request management module MG1 counts votes, for example. If the service application is a betting application, the service application request management module MG1 provides book-keeping services in respect of the results of bets or provides the interface between the terminal Ti placing the bet and the server that controls betting (for example the server of a horse race company).

It is important to note that, in the context of an interactive application, some requests or messages sent by a terminal Ti may generate in return the transmission by the service application management module MG1 of one or more messages (or requests) to the terminal Ti concerned.

Of course, in the context of executing an interactive service application via a return channel, the exchange of messages (or requests) between a terminal Ti and the control equipment EC is effected under the control of the user of the terminal Ti. More precisely, it is the actions effected by the user by means of his terminal Ti, for example to respond to a query displayed on his screen, that trigger the sending of a request (or message) to the control equipment EC.

Several ways of determining a service application to be executed locally (in a terminal Ti) may be envisaged.

A first way is to adapt the definition module MD, more precisely its first sub-module M1, so that it integrates into the contents the data that represents the service applications of each group corresponding to an interactivity point. For example, this application data may be placed just after the associated interactivity point. This is not obligatory, however.

In this case, the definition module MD must either include a memory in which all the application data is stored or be able to access equipment accessible via the second network R2 in which all application data is stored.

Also, in this case, the processing module MT of each terminal Ti must be adapted to determine locally the service application that must be executed by the associated display module as a function of each criterion selected. To this end it must, on the one hand, be able to extract application data from content data streams received by the associated display module MA and, on the other hand, have available the criterion or criteria that must be applied to the data in order to select that representing the application that must be executed locally.

Each criterion to be applied locally may be defined locally by the user of the terminal Ti or remotely by the broadcast operator.

In the former case, the processing module MT may make available to the user of the terminal Ti a list from which he can select each criterion to be applied, for example. In the latter case, each definition of a criterion to be applied is sent to the terminal Ti concerned by the control equipment EC via a return channel (of the second network R2), either before receiving the streams (which is preferable from the transmission delay point of view) or at the request of the processing module MT, after receiving application data.

It is important to note that the criteria applied may vary as a function of the program types and/or time bands and/or sex and/or tastes and/or areas of interest and/or leisure activities of the person who wishes to watch a program, for example. In this case, a plurality of groups of criteria may be stored either in the terminal Ti (more precisely in the processing module MT), in which case the user chooses one of them as a function of his requirements, or in the control equipment EC, in which case it is the content broadcaster that chooses the group to be applied.

Once a processing module MT has determined a service application, it communicates it to the display module MA of its terminal Ti in order for the latter to execute it.

A second way is to adapt each processing module MT so that each time it detects an interactivity point it sends the control equipment EC (via its terminal Ti and the return channel of the second network R2) a service application request that preferably contains the identifier of the interactivity point detected.

For example, the control equipment EC in this case includes a control module MC which, when it receives a service application request from a terminal Ti (over a return channel of the second network R2), determines each criterion definition that corresponds to the requesting terminal Ti (and to its user) as well as (application) data representing service applications to which it will apply each selected criterion in order to select those that represent a service application selected for the requesting terminal Ti.

To enable this, on the one hand, the control equipment EC may, for example, comprise (as shown) a generation module MG2 in which groups of service applications and groups of criteria are stored in corresponding relationship to interactivity points and, on the other hand, first memory means BP must be provided for storing the user profiles and/or the types of the customer terminals Ti and/or second memory means BL must be provided for storing the locations of the terminals Ti.

The groups of service applications are defined by a technician of the broadcaster using the generation module MG2 as an interface, for example as a function of the content types.

The first memory means BP and/or the second memory means BL may form part of the control equipment EC, for example, or belong to the content broadcaster, or, as in the example shown in FIG. 1, be accessible to the control equipment EC via the second network R2 to which it is connected. In the second instance, the control equipment EC accesses the first memory means BP and/or the second memory means BL via the second network R2 and via a third network, for example of the IP type, to which they are connected. In the third instance, this may refer to the memory means of the operator of the second network R2, for example, who is not necessarily the same as the content broadcaster using the first network R1. For example, in a mobile type second network R2, on the one hand, the second location means may be the location database known as the home location register (HLR) that is part of the core network and, on the other hand, the first memory means BP may be either the HLR in the case of a 3G network or the home subscriber server (HSS) in the case of an IMS network.

Building an information database by aggregating, synthesizing and updating user profiles based on information supplied by the telecommunication operator (second network R2) and/or the broadcast operator (first network R1) and/or on evaluating user behavior (for example by analyzing their requests, votes and the like) may also be envisaged.

When the control module MC receives a service application request from a requesting terminal Ti it first determines from the generation module MG2 the group of service applications and the group of criteria that correspond to the application point that is the subject of the request. Then, according to the group determined in this way and containing that criterion, it accesses the first memory means BP and/or the second memory means BL to determine the profile and/or type and/or location (and/or network type) data that corresponds to the terminal Ti. For example, it determines both the location of the terminal Ti and the profile of its user.

The control module MC then applies to the group of service applications determined in this way the profile and/or type and/or location and/or network type data that has been determined that constitutes the associated group of criteria. This enables it to determine a service application personalized for the requesting terminal Ti. It then generates a message including data representing the service application that has been determined and communicates that message to its control equipment EC in order for the latter to forward it to the requesting terminal Ti via its return channel (of the second network R2).

When the requesting terminal Ti receives this message, it communicates it to its display module MA in order for the latter to execute the service application that is defined by the data that it contains under the control of its processing module MT.

A third way is a combination of the first and second ways. As in the first way, the definition module MD, more precisely its first sub-module M1, integrates into the contents to be broadcast data that represents a first portion of each service application of each group corresponding to an interactivity point. Also, as in the second way, the control equipment EC may comprise a generation module MG2, but in this case one storing only groups of second service application portions complementary to the first portions stored in the definition module MD and preferably in corresponding relationship to interactivity points.

Each time that a processing module MT detects an interactivity point in a stream received by the display module MA of its terminal Ti, it sends the control equipment EC (via its terminal Ti and a return channel of the second network R2) a request to obtain second service application portions, the request preferably containing the detected interactivity point.

When the control equipment EC receives a request of this kind from a requesting terminal Ti (on a return channel), it forwards it to its control module MC, whose generation module MG2 determines the data that represents the second portions of the service applications of the group associated with the interactivity point designated by the received request.

The control module MC then generates a message including the data that has been determined, representing the second portions of the service applications, and communicates that message to its control equipment EC in order for it to forward it to the requesting terminal Ti via its return channel (of the second network R2).

When the requesting terminal Ti receives this message, it communicates it to its processing module MT in order for the latter to determine locally the service application that must be executed by the associated display module MA as a function of each selected criterion. To do this it first uses the data from the first portions of the service applications extracted from the content data stream and the data from the second portions of the same service applications supplied by the control equipment EC in order to reconstitute the group of service applications corresponding to the detected interactivity point. It then applies each selected criterion to the application data in order to select the data that represents the application that must be executed locally by the display module MA.

As in the first option, each criterion to be applied locally may be defined locally by the user of the terminal Ti or defined remotely by the broadcast operator (and sent by the control equipment EC via a return channel of the second network R2).

Once the processing module MT has determined a service application, it communicates it to the display module MA of its terminal Ti in order for the latter to execute it.

The types of messages and requests exchanged between the terminals Ti and the control equipment EC on the return channels of the second network R2 depend on the type of terminal Ti. Thus they may take the form of SMS (Short Message Service), MMS (Multimedia Message Service), WAP (Wireless Application Protocol) or electronic mail (e-mail) messages or IP requests or requests in a proprietary format, via dedicated servers, or HTML pages.

A second embodiment of the invention is described next with reference to FIG. 2.

In this second embodiment, a single (first) network R1 provides one-way broadcasting of contents to terminals and two-way communication between the network R1 and said terminals on return channels. A network R1 of this kind is a fixed cable network or an xDSL network including medium- or high-bit-rate transmission lines (for broadcasting) and low-bit-rate transmission lines (for communication), for example.

The mode of operation of this broadcast system has many similarities with that described above with reference to FIG. 1. The main difference is that all the modules (MD) and equipments (SC, EC, BP, BL, SF, Ti) involved in any of the three options mentioned (which also apply here) are now coupled to a single network R1 (taken as a whole, rather than only the portion thereof dedicated to one-way broadcasting). Moreover, the terminals Ti are now fixed terminals except in the case of WiFi, WiMAX and similar networks. Also, in the case of a single network R1, broadcasting is always on one-way transmission channels, whereas communication is effected via communication channels defining return channels. Moreover, it may be necessary to correlate the broadcast channels and the return channels, in particular to determine the location of the terminals.

Three illustrative and nonlimiting examples follow.

A first example consists in defining two groups of users: a first group to which a voting application is offered at a given time in a broadcast program and a second group to which a (possibly chargeable) telephone ringtone downloading application is offered at the same given time in the same broadcast program.

A second example consists in defining two groups of users: a first (for example male) group that is offered an application displaying a first group of advertisements at a given time in a broadcast program and a second (for example female) group that is offered an application displaying a second group of advertisements (at least partly different from the first group) at the same given time in the same broadcast program.

A third example consists in defining two user groups: a first group (for example in a first geographical area) to which a standard voting (question/response) application is offered at a given time in a broadcast program and a second group (for example in a second geographical area) offered the same voting application at the same given time in the same broadcast program but with questions incorporating in a dedicated field one or more items of personalized information, for example the name of each user, his geographical location or his age (preferably on his birthday).

The broadcasting system of the invention, and in particular its definition module MD and its processing module MT, together with its control module MC, service application request management module MG1 and generation module MG2, where applicable, may take the form of electronic circuits, software (or electronic data processing) modules or a combination of circuits and software.

If the processing modules MT are entirely implemented in the form of a software module, they may be installed in the terminals during fabrication or commissioning thereof or downloaded into the terminals via their parent networks.

The invention is not limited to the broadcasting system and broadcasting method embodiments described above by way of example only and encompasses all variants that the person skilled in the art might envisage that fall within the scope of the following claims.

1. Method of broadcasting content data streams to communication terminals (Ti) attached to at least one first broadcast network (R1), characterized in that it consists in inserting at least interactivity points at selected places in contents to be broadcast in the form of streams, each corresponding to the triggering at a selected time of a service application belonging to a group of at least two selected applications and, in the event of reception in a destination terminal (Ti) of said streams broadcast via said first network (R1), displaying the data that they contain and, in the event of detecting an interactivity point, determining the corresponding service application as a function of at least one selected criterion relating at least to the user of said terminal (Ti) and/or to said terminal (Ti), so that said service application is executed by said terminal (Ti).

2. Method according to claim 1, characterized in that each criterion is selected from a group comprising at least a terminal (Ti) user profile criterion, a terminal (Ti) type criterion, a terminal (Ti) location criterion and a return channel type criterion.

3. Method according to claim 1, characterized in that at least some of said service applications are of the interactive type.

4. Method according to claim 2, characterized in that at least some of said service applications are of the interactive type.

5. Method according to claim 3, characterized in that said interactive service applications are selected from a group comprising at least a betting application, a voting application, a purchasing application and a personalized data downloading application.

6. Method according to claim 3, wherein, in the event of executing an interactive service application in a terminal (Ti), messages are exchanged via a return channel set up between said terminal (Ti) and a selected address of said first network (R1) or of a two-way second communication network (R2) under the control of the user of said terminal (Ti).

7. Method according to claim 5, wherein, in the event of executing an interactive service application in a terminal (Ti), messages are exchanged via a return channel set up between said terminal (Ti) and a selected address of said first network (R1) or of a two-way second communication network (R2) under the control of the user of said terminal (Ti).

8. Method according to claim 6, characterized in that said personalized data is selected from a group comprising at least telephone ringtones, text messages, videos, advertisements, games, security information and general or specialized information.

9. Method according to claim 1, characterized in that at least some of said service applications are of the interactive type, characterized in that at least one of said service applications is dedicated to displaying at least one selected advertisement and/or non-interactive information.

10. Method according to claim 5, characterized in that at least some of said service applications are of the interactive type, characterized in that at least one of said service applications is dedicated to displaying at least one selected advertisement and/or non-interactive information.

11. Method according to claim 1, characterized in that said contents to be broadcast integrate data representing service applications of each group corresponding to an interactivity point and the service application to be executed is determined in a terminal (Ti) as a function of each selected criterion.

12. Method according to claim 1, characterized in that said contents to be broadcast integrate data representing a first portion of each service application of each group corresponding to an interactivity point and, in the event of detection of an interactivity point in a terminal (Ti), a request is sent to a selected address of the first network (R1) or the second network (R2) via a return channel thereof to obtain each complementary second portion that is complementary to a first service application portion that has been received, and then, on receiving each second portion, said service application is determined in said terminal (Ti) as a function of each selected criterion in order for it to be possible to execute it.

13. Method according to claim 11, characterized in that each selected criterion is defined by the user of said terminal (Ti).

14. Method according to claim 12, characterized in that each selected criterion is defined by the user of said terminal (Ti).

15. Method according to claim 11, characterized in that each selected criterion is defined by the broadcast operator and sent to the corresponding terminal (Ti) via a return channel.

16. Method according to claim 12, characterized in that each selected criterion is defined by the broadcast operator and sent to the corresponding terminal (Ti) via a return channel.

17. Method according to claim 1, characterized in that, in the event of detection of an interactivity point in a terminal (Ti), a service application request is sent to a selected address of the first network (R1) or the second network (R2) via a return channel and then, on reception of that request, the required service application is determined as a function of each selected criterion corresponding to said requesting terminal (Ti) and defined by the broadcast operator and said service application is sent to said requesting terminal (Ti) in order for it to be able to execute it.

18. System for broadcasting content data streams to communication terminals (Ti) attached at least to a first broadcast network (R1), characterized in that it comprises at least i) data content definition means (MD) adapted to insert at least interactivity points at selected places in contents to be broadcast in the form of streams, each corresponding to the triggering at a selected time of a service application belonging to a group of at least two selected applications, ii) a content server (SC) adapted to broadcast content data streams supplied by said definition means (MD) to terminals (Ti) via said first network (R1), and iii) processing means (MT) installed in terminals (Ti), further including display means (MA) adapted to display data contained in streams received from said content server (SC) and adapted to analyze the data of said streams in order, in the event of detection of an interactivity point, to determine the corresponding service application as a function of at least one selected criterion relating at least to the user of said terminal (Ti) and/or to said terminal (Ti), and to command the display means (MA) of their terminal (Ti) to execute that service application.

19. System according to claim 18, characterized in that each criterion is selected from a group comprising at least a terminal (Ti) user profile criterion, a terminal (Ti) type criterion, a terminal (Ti) location criterion and a return channel type criterion.

20. System according to claim 18, characterized in that it comprises control equipment (EC) that is accessible at a selected address via a return channel of said first network (R1) or a bidirectional second communication network (R2) and includes service application request management means (MG1) and said processing means (MT) of a terminal (Ti) are adapted, in the event of execution of an interactive type service application by said display means (MA) of said terminal (Ti), to exchange messages with said service application request management means (MG1) via a return channel set up between its control equipment (EC) and said terminal (Ti) and under the control of the user of said terminal (Ti).

21. System according to claim 18, characterized in that said definition means (MD) are adapted to integrate into said contents to be broadcast data representing the service applications of each group corresponding to an interactivity point and said processing means (MT) of each terminal (Ti) are adapted to determine the service application to be executed by said display means (MA) of said terminal (Ti) as a function of each selected criterion.

22. System according to claim 20, characterized in that said definition means (MD) are adapted to integrate into said contents to be broadcast data representing a first portion of each service application of each group corresponding to an interactivity point and said control equipment (EC) comprises control means (MC) adapted to determine on demand data representing second service application portions complementary to the first portions and said processing means (MT) of each terminal (Ti) are adapted, in the event of detection of an interactivity point, to send said control equipment (EC) via said return channel a request to obtain each complementary second portion that is complementary to a first service application portion that has been received and, on reception of each second portion, to determine said service application as a function of each selected criterion and to command said display means (MA) of said terminal (Ti) to execute that service application.

23. System according to claim 22, characterized in that said processing means (MT) of each terminal (Ti) are adapted to store each selected criterion defined by the user of said terminal (Ti).

24. System according to claim 22, characterized in that said processing means (MT) of each terminal (Ti) are adapted to store each selected criterion defined by the broadcast operator and sent to the corresponding terminal (Ti) via said return channel.

25. System according to claim 20, characterized in that said processing means (MT) of each terminal (Ti) are adapted, in the event of detection of an interactivity point, to send said control equipment (EC) a service application request via said return channel and said control equipment (EC) comprises control means (MC) adapted, on receiving a service application request, to determine each criterion definition corresponding to the requesting terminal (Ti) and data representing service applications and then to determine the required service application as a function of each criterion that has been determined and to generate a message including data representing said service application that has been determined in order for the control equipment (EC) to send it to the requesting terminal (Ti) via said return channel, after which the display means (MA) of said requesting terminal (Ti) execute that service application under the control of its processing means (MT).
